(19) United States
(12) Patent Application Publication
(10) Pub. No.: US 2015/0370619 A1
(43) Pub. Date: Dec. 24, 2015

(54) MANAGEMENT SYSTEM FOR MANAGING COMPUTER SYSTEM AND MANAGEMENT METHOD THEREOF

(71) Applicant: HITACHI, LTD., Chiyoda-ku, Tokyo (JP)

(72) Inventors: Masataka NAGURA, Tokyo (JP); Jun NAKAJIMA, Tokyo (JP); Tomohiro MORIMURA, Tokyo (JP); Yutaka KUDO, Tokyo (JP)

(73) Assignee: Hitachi, Ltd., Tokyo (JP)

(21) Appl. No.: 14/763,950

(22) PCT Filed: Sep. 18, 2013
(86) PCT No.: PCT/JP2013/075104

§ 371 Date: Jul. 28, 2015

(51) Int. Cl. G06F 9/54; G06F 11/30; G06F 11/34

(52) U.S. Cl. CPC G06F 9/542; G06F 11/3409; G06F 11/3024

(57) ABSTRACT

Provided is a management system managing a computer system including apparatuses to be monitored. The management system holds configuration information on the computer system, analysis rules and plan execution effect rules. The analysis rules each associates a causal event that may occur in the computer system with derivative events that may occur by effects of the causal event and defines the causal event and the derivative events with types of components in the computer system. The plan execution effect rules each indicates types of components that may be affected by a computer system configuration change and specifics of the effects. The management system identifies a first event that may occur when a first plan changing the computer system configuration is executed using the plan execution effect rules and the configuration information, and identifies a range where the first event affects using the analysis rules and the configuration information.

### BACKGROUND

This invention relates to a management system for managing a computer system and a management method thereof.

Patent Literature 1 discloses identifying a failure cause by selecting a causal event causing performance degradation and related events caused thereby. Specifically, an analysis engine for analyzing causal relationship of a plurality of failure events that occur in the apparatuses under management applies predefined analysis rules each including a conditional sentence and an analysis result to the events that performance data of apparatuses under management exceeds a threshold to select the foregoing events.

Patent Literature 2 discloses a method of cause diagnosis using a log for failure identification and a method to invoke a resolution module based on the diagnosis outcome upon occurrence of a failure.

Patent Literature 1: JP 2010-86115 A

Patent Literature 2: U.S. 2004/0225381 A

### SUMMARY

To cope with a failure identified by the technique disclosed in JP 2010-86115 A, there exists a problem that a specific failure recovery method cannot be found so that the failure recovery costs much. The technique of U.S. 2004/0225381 A may be able to solve this problem since it performs mapping between the log diagnosis method for identifying a failure cause and the method of invoking a resolution module using the diagnostic outcome to achieve speedy recovery upon identification of the failure cause.

In a common computer system, however, a plurality of server computers and storage apparatuses work together over a network. In such a configuration, not being limited to the recovery processing, processing of some apparatus may affect a different apparatus. For this reason, the system is required to be stopped before automatically executing some processing and pursue the processing after the system administrator admits the processing.

An aspect of the invention is a management system for managing a computer system including a plurality of apparatuses to be monitored. The management system includes a memory and a processor. The memory holds configuration information on the computer system, analysis rules each associating a causal event that may occur in the computer system with derivative events that may occur by effects of the causal event and defining the causal event and the derivative events with types of components in the computer system, and plan execution effect rules each indicating types of components that may be affected by a configuration change in the computer system and specifics of the effects. The processor is configured to identify a first event that may occur when a first plan for changing a configuration of the computer system is executed using the plan execution effect rules and the configuration information, and identify a range where the first event affects using the analysis rules and the configuration information.

An aspect of the invention can provide a computer system with more pertinent management, considering effects of a configuration change in the computer system.

### BRIEF DESCRIPTION OF THE DRAWINGS

FIG. 1 is a diagram illustrating a concept of a computer system according to the first embodiment;

FIG. 2 is a diagram illustrating an example of a physical configuration of the computer system;

FIG. 3 is a conceptual diagram illustrating a state described in the first embodiment;

FIG. 4 is a diagram illustrating a configuration example of an apparatus performance management table held in a management server computer in the first embodiment;

FIG. 5 is a diagram illustrating a configuration example of a file topology management table held in the management server computer in the first embodiment;

FIG. 6 is a diagram illustrating a configuration example of a network topology management table held in the management server computer in the first embodiment;

FIG. 7 is a diagram illustrating a configuration example of a VM configuration management table held in the management server computer in the first embodiment;

FIG. 8 is a diagram illustrating a configuration example of an event management table held in the management server computer in the first embodiment;

FIG. 9A is a diagram illustrating a configuration example of an analysis rule held in the management server computer in the first embodiment;

FIG. 9B is a diagram illustrating a configuration example of an analysis rule held in the management server computer in the first embodiment;

FIG. 10 is a diagram illustrating a configuration example of an analysis result management table held in the management server computer in the first embodiment;

FIG. 11 is a diagram illustrating a configuration example of a generic plan repository held in the management server computer in the first embodiment;

FIG. 12 is a diagram illustrating a configuration example of an expanded plan held in the management server computer in the first embodiment;

FIG. 13 is a diagram illustrating a configuration example of a rule-and-plan association management table held in the management server computer in the first embodiment;

FIG. 14 is a diagram illustrating a configuration example of a plan execution effect rule held in the management server computer in the first embodiment;

FIG. 15 is a flowchart for illustrating a processing flow from performance information acquisition, through failure cause analysis and plan expansion, to plan execution effect analysis, which are executed by the management server computer in the first embodiment;

FIG. 16 is a flowchart for illustrating the plan expansion, which is executed by the management server computer in the first embodiment;

FIG. 17 is a flowchart for illustrating the plan execution effect analysis, which is executed by the management server computer in the first embodiment;

FIG. 18 is a diagram illustrating an example of an image of a solution plan list to be presented to the administrator in the first embodiment;

FIG. 19 is a diagram illustrating a configuration example of a plan execution record management table held in the management server computer in the second embodiment;

FIG. 20 is a flowchart for illustrating the plan execution effect analysis, which is executed by the management server computer in the second embodiment; and

FIG. 21 is a diagram illustrating an example of an image of a solution plan list to be presented to the administrator in the second embodiment.

### DETAILED DESCRIPTION OF THE EMBODIMENTS

Hereinafter, embodiments of this invention will be described with reference to the accompanying drawings. It should be noted that this invention is not limited to the examples described hereinafter. In the following description, information in the embodiments will be expressed as “aaa table”, “aaa list”, and the like; however, the information may be expressed in a data structure other than the table, list, and the like.

To imply independency from the data structure, the “aaa table”, “aaa list”, and the like may be referred to as “aaa information”. Furthermore, in describing the specifics of the information, terms such as “identifier”, “name”, “ID”, and the like are used; but they may be replaced with one another.

In the following description, descriptions may be provided with subjects of “program” but such descriptions can be replaced by those having subjects of “processor” because a program is executed by a processor to perform predetermined processing using a memory and a communication port (communication control device).

Furthermore, the processing disclosed by the descriptions having the subjects of program may be regarded as the processing performed by a computer such as a management computer or an information processing apparatus. A part or the entirety of a program may be implemented by dedicated hardware. Various programs may be installed in computers through a program distribution server or a computer-readable storage medium.

Hereinafter, an aggregation of one or more computers for managing the information processing system and showing information to be displayed in this invention may be referred to as management system. In the case where the management computer shows the information to be displayed, the management computer is the management system. The pair of a management computer and a display computer is also the management system. For higher speed or higher reliability in performing management jobs, multiple computers may perform the processing equivalent to that of the management computer; in this case, the multiple computers (including a display computer if it shows information) are the management system.

### First Embodiment

### <Overview>

This embodiment prepares patterns of configuration change plans for a computer system and components which could be directly affected by the execution of the plans and identifies the apparatuses which could be secondarily affected based on the configuration information on the computer system and analysis rules defining cause and effect relations.

When presenting a plan to be executed on the computer system to the system administrator, this embodiment presents the effects of the execution of the plan as well. This embodiment can help the system administrator determine whether to execute the plan. For example, in the case of a failure recovery plan, the time until the recovery can be shortened.

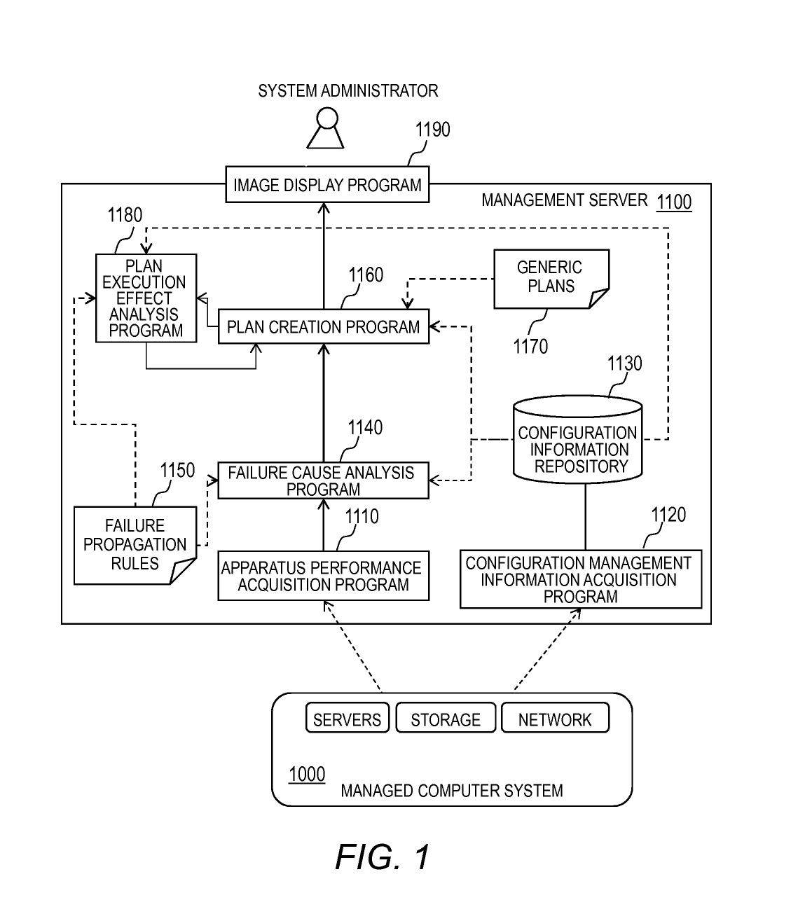

FIG. 1 is a conceptual diagram of a computer system in the first embodiment. This computer system includes a managed computer system 1000 and a management server 1100 connected with it via a network.

An apparatus performance acquisition program 1110 and a configuration management information acquisition program 1120 monitor the managed computer system 1000. The configuration management information acquisition program 1120 records configuration information in a configuration information repository 1130 at every configuration change.

When the apparatus performance acquisition program 1110 detects a failure occurring in the managed computer system 1000 from the acquired apparatus performance information, it invokes a failure cause analysis program 1140 to identify the cause.

The failure cause analysis program 1140 identifies the cause of the failure. Standardized failure propagation rules are defined in failure propagation rules 1150. The failure cause analysis program 1140 checks the failure propagation rules 1150 with the configuration information acquired from the configuration information repository 1130 to identify the failure cause.

The failure cause analysis program 1140 invokes a plan creation program 1160 to create a solution plan of the identified cause. The plan creation program 1160 creates a specific solution plan (expanded plan) using a generic plan 1170 for which relations between failures and the plan are predefined as a pattern.

A plan execution effect analysis program 1180 identifies apparatuses, elements within the apparatuses, and programs to be affected by executing the solution plan created by the plan creation program 1160. Hereinafter, each of the apparatuses and the elements (both of the hardware elements and the programs) within the apparatuses is referred to as a component.

The plan execution effect analysis program 1180 identifies effects of execution of the created solution plan by checking the solution plan and the configuration information provided by the configuration information repository 1130 with the failure propagation rules 1150.

An image display program 1190 shows the system administrator the created solution plan with the effect range of execution of the solution plan. The first embodiment describes a solution plan created following the identification of the failure cause by the failure cause analysis program 1140; however, this invention is not limited to the identification of the failure cause but is applicable to identification of effects of various plans which require some configuration change in the computer system.

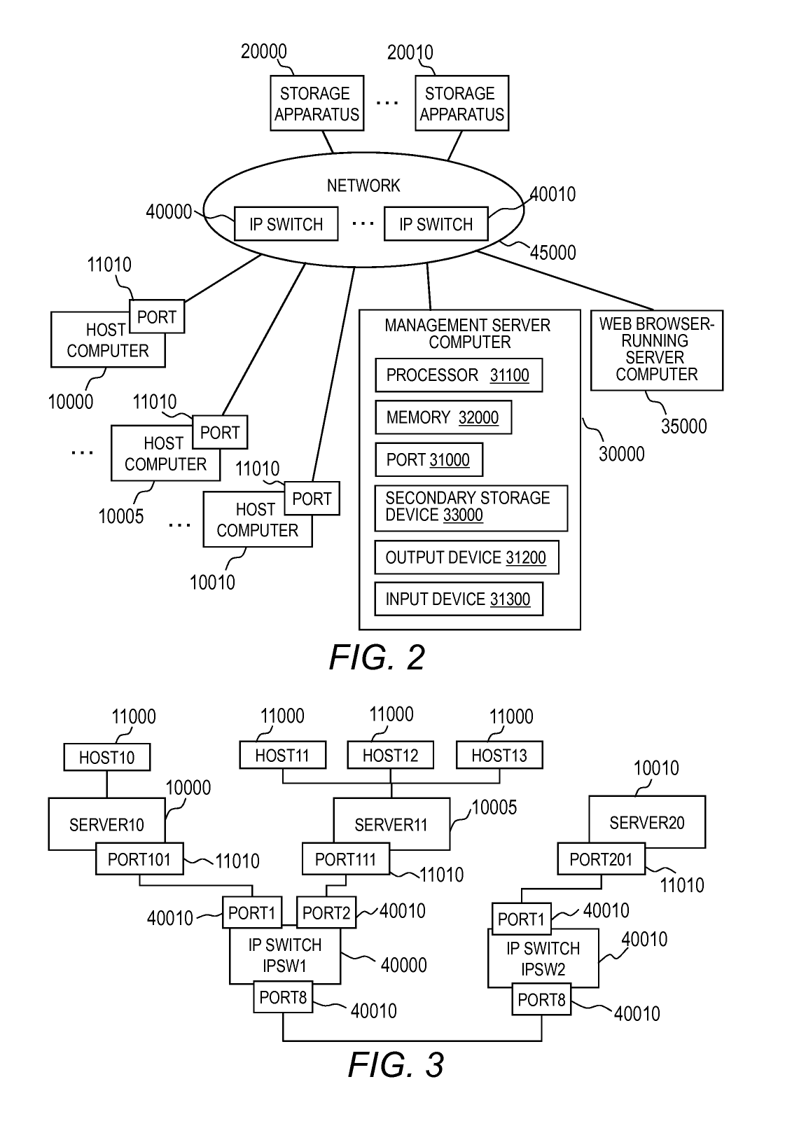

FIG. 2 illustrates an example of a physical configuration of the computer system in this embodiment. The computer system includes a storage apparatus 20000, a host computer 10000, a management server computer 30000, a web browser-running server computer 35000, an IP switch 40000, which are connected via a network 45000. A part of the apparatuses in FIG. 2 may be omitted and only a part of the apparatuses may be interconnected.

Each of the host computers 10000 to 10010 receives file I/O requests from not-shown client computers connected therewith and accesses the storage apparatuses 20000 to 20010 based on the requests, for example,. In this description, the host computers 10000 to 10010 are server computers.

In the host computers 10000 to 10010, programs communicate with one another via the network 45000 to exchange files. For this purpose, each of the host computers 10000 to 10010 has a port 11010 to connect with the network 45000. The management server computer 30000 manages operations of the entire computer system.

The web browser-running server computer 35000 communicates with the image display program 1190 in the management server computer 30000 via the network 45000 to display a variety of information on the web browser. The user refers to the information displayed on the web browser in the web browser-running server to manage the apparatuses in the computer system. It should be noted that the management server computer 30000 and the web browser-running server 35000 may be configured with a single server computer.

### <Example of System Configuration>

FIG. 3 is a conceptual diagram illustrating an example of a system configuration which is consistent with the tables held by the management server computer 30000, which will be described hereinafter. In this diagram, the IDs of the IP switches 40000 and 40010 are IPSW1 and IPSW2, respectively. Each of the IP switches IPSW1 and IPSW2 has ports 40010 to connect to the network 45000.

The IDs of the ports 40010 of the IP switch IPSW1 are PORT1, PORT2, and PORT8. The IDs of the ports 40010 of the IP switch IPSW2 are PORT1 and PORT8. The IDs of the ports are unique to an IP switch.

The IDs of the host computers 10000, 10005, and 10010 are SERVER10, SERVER11, and SERVER20, respectively. The host computers 10000, 10005, and 10010 are connected to the network 45000 via ports 10010. The IDs of their respective ports are PORT101, PORT111, and PORT201.

In this configuration example, each of the host computers 10000, 10005, and 10010 runs a server virtualization mechanism (server virtualization program); virtual machines (VMs) 11000 are running on the host computers 10000 and 10005. The IDs of the VMs 11000 are HOST10 to HOST13. Although not shown, it is assumed that an OS is installed in each VM 11000 and web services are running thereon.

### <Physical Configuration of Management Server Computer>

As illustrated in FIG. 2, the management server computer 30000 includes a port 31000 for connecting to the network 45000, a processor 31100, a memory 32000 such as a cache memory, and a secondary storage device 33000 such as an HDD. Each of the memory 32000 and the secondary storage device 33000 is made of either a semiconductor memory or a non-volatile storage device, or both of a semiconductor memory and a non-volatile storage device.

The management server computer 30000 further includes an output device 31200, such as a display device, for outputting later-described processing results and an input device 31300, such as a keyboard, for the administrator to input instructions. These are interconnected via an internal bus.

The memory 32000 holds the programs and data 1110 to 1190 shown in FIG. 1 and other programs and data. Specifically, the memory 32000 holds an apparatus performance management table 33100, a file topology management table 33200, a network topology management table 33250, a VM configuration management table 33280, and an event management table 33300.

The memory 32000 further holds an analysis rule repository 33400, an analysis result management table 33600, a generic plan repository 33700, an expanded plan repository 33800, a rule-and-plan association management table 33900, and a plan execution effect rule repository 33950.

The configuration information repository 1130 in FIG. 1 stores the file topology management table 33200, the network topology management table 33250, and the VM configuration management table 33280. The failure propagation rules 1150 are stored in the analysis rule repository 33400. The generic plans 1170 are stored in the generic plan repository 33700.

In this example, functional units are implemented by the processor 31100 executing the programs in the memory 32000. Unlike this, the functional units which are implemented by the programs and the processor 31100 in this example may be provided by hardware modules. Distinct boundaries do not need to exist between programs.

The image display program 1190 displays acquired configuration management information with the output device 31200 in response to a request from the administrator through the input device 31300. The input device and the output device may be separate devices or one or more united devices.

For example, the management server computer 30000 includes a keyboard and a pointer device as the input device 31300 and a display device and a printer as the output device 31200; however, the input and output devices may be devices other than these.

As an alternative of the input and output devices, an interface such as a serial interface or an Ethernet interface may be used. The interface is connected with a display computer including a display device, a keyboard, and a pointer device so that inputting and displaying by the input/output devices can be replaced by transmitting information to be displayed to the display computer or receiving information to be input from the display computer through the interface.

If the management server computer 30000 displays information to be displayed, the management server computer 30000 is a management system. Also, the pair of the management server computer 30000 and the display computer (for example, the web browser-running server computer 35000 in FIG. 2) is also a management system.

### <Configuration of Apparatus Performance Management Table>

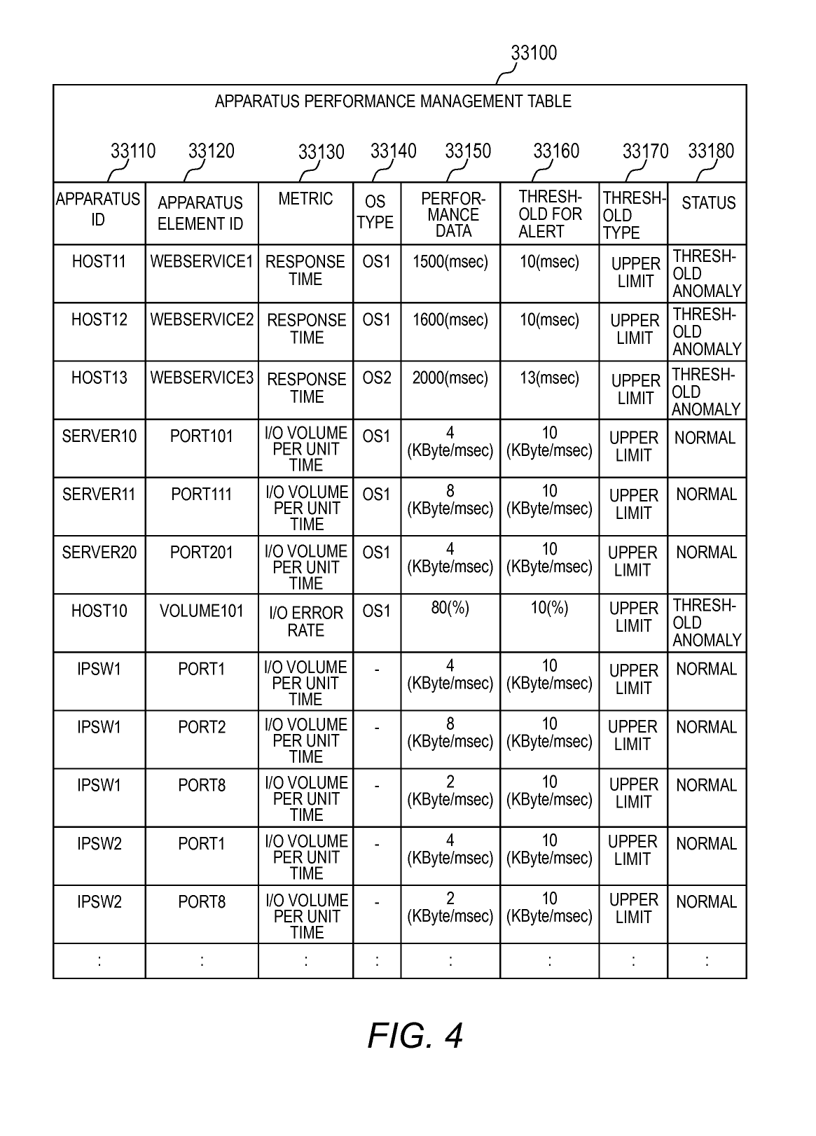

FIG. 4 illustrates a configuration example of the apparatus performance management table 33100 held in the management server computer 30000. The apparatus performance management table 33100 manages performance information of the apparatuses in the managed system and includes a plurality of configuration items. The apparatus performance management table 33100 indicates actual performance of the apparatuses in operation, not the performance according to the specifications.

Each field 33110 stores an apparatus ID to be the identifier of an apparatus to be managed. Apparatus IDs are assigned to physical apparatuses and virtual machines. Each field 33120 stores the ID of an element inside the managed apparatus. Each field 33130 stores the metric name of performance information of the managed apparatus. Each field 33140 stores the OS type of the apparatus in which a threshold anomaly (meaning a determination made to be abnormal compared to the threshold) is detected.

Each field 33150 stores actual performance data of the managed apparatus acquired from the apparatus. Each field 33160 stores a threshold (threshold for an alert), which is an upper or lower limit of the normal range of the performance data for the managed apparatus, and is input by the user. Each field 33170 stores a value indicating whether the threshold is an upper limit or a lower limit of the normal range. Each field 33180 stores a status indicating whether the performance data is a normal value or an abnormal value.

For example, the first row (first entry) in FIG. 4 indicates that the response time of WEBSERVICE1 running on HOST11 is currently 1500 msec (refer to the field 33150).

Furthermore, if the response time of WEBSERVICE1 is longer than 10 msec (refer to the field 33160), the management server computer 30000 determines that WEBSERVICE1 is overloaded. In this example, the performance data is determined to be an abnormal value (refer to the fields 33150 and 33180). When this data is determined to be an abnormal value, the abnormal state is written to a later-described event management table 33300 as an event.

This example provides the response time, the I/O volume per unit time, and the I/O error rate for the performance data of the apparatuses managed by the management server computer 30000; however, the management server computer 30000 may manage performance data different from these.

The field 33160 may store a value automatically determined by the management server computer 30000. For example, the management server computer 30000 may determine outliers by baseline analysis from the previous performance data and store the information of an upper threshold or a lower threshold determined from the outliers in the fields 33160 and 33170.

The management server computer 30000 may make determination about the abnormal state (whether to issue an alert) using the performance data in a predetermined period in the past. For example, the management server computer 30000 acquires performance data in a predetermined period in the past and analyzes the tendency of the variation of the performance data. If the analysis result indicates elevating/lowering tendency and predicts that the performance data will exceed the upper threshold or fall below the lower threshold after a certain time period in future in the case where the performance data varies in the same tendency, the management server computer 30000 may write the abnormal state to the later-described event management table 33300 as an event.

### <Configuration of File Topology Management Table>

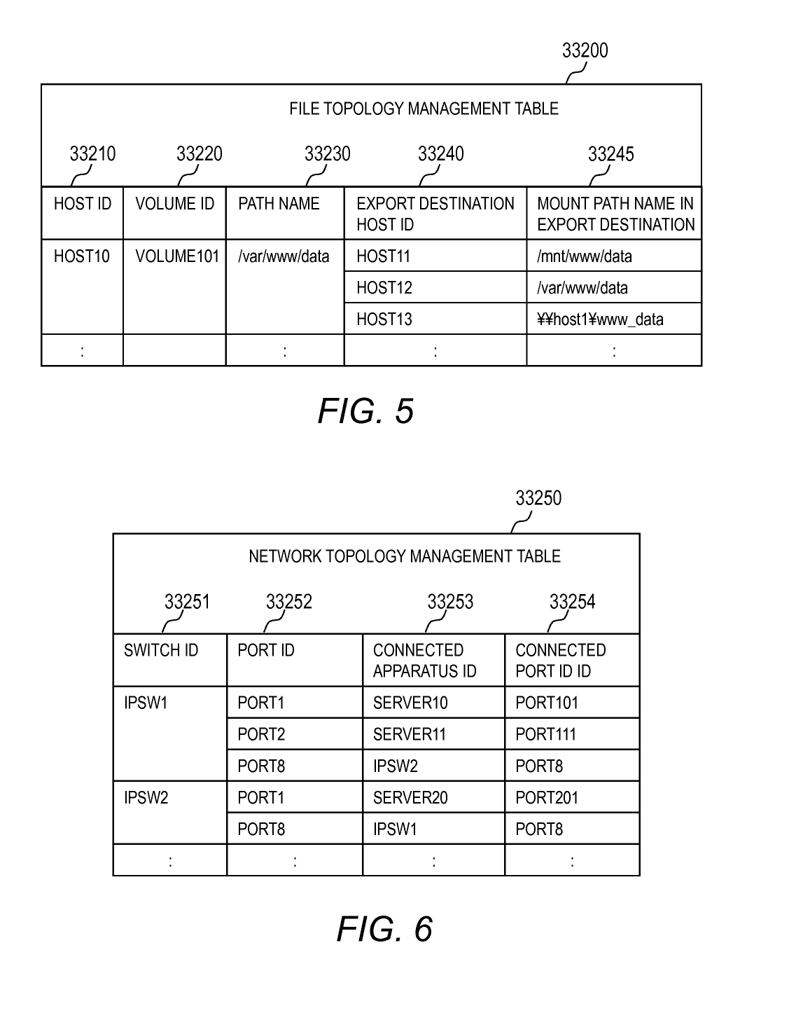

FIG. 5 illustrates a configuration example of the file topology management table 33200 held in the management server computer 30000. The file topology management table 33200 indicates the conditions of use of volumes and includes a plurality of configuration items.

Each field 33210 stores the ID of a host (VM). Each field 33220 stores the ID of a volume provided to the host. Each field 33230 indicates a path name, which is an identification name of the volume when it is mounted on the host.

Each field 33240 indicates, if a file system in the host identified by the path name is open to another host, the ID of the export destination host or the host to which the file system is open. Each field 33245 indicates the name of the path where the export destination host mounts the file system.

For example, the first row (first entry) in FIG. 5 indicates that, in the host having an ID of HOST10, a volume VOL101 is mounted under a path name of /var/www/data. The file system having this path name is open to the hosts identified by HOST11, HOST12, and HOST13. In each of these hosts, the file system is mounted under a path name of /mnt/www/data, /var/www/data, or ¥¥host1¥www_data.

### <Configuration of Network Topology Management Table>

FIG. 6 illustrates a configuration example of the network topology management table 33250 held in the management server computer 30000. The network topology management table 33250 manages the topology of the network including switches, specifically, manages connections between switches and other apparatuses.

The network topology management table 33250 includes a plurality of items. Each field 33251 stores the ID of an IP switch, which is a network apparatus. Each field 33252 stores the ID of a port included in the IP switch. Each field 33253 indicates the ID of an apparatus connected with the port. Each field 33254 indicates the ID of a connected port in the connected apparatus.

For example, the first row (first entry) in FIG. 6 indicates that a port having an ID of PORT1 of an IP switch having an ID of IPSW1 is connected with a port having an ID of PORT101 in a host computer having an ID of SERVER10.

### <Configuration of VM Configuration Management Table>

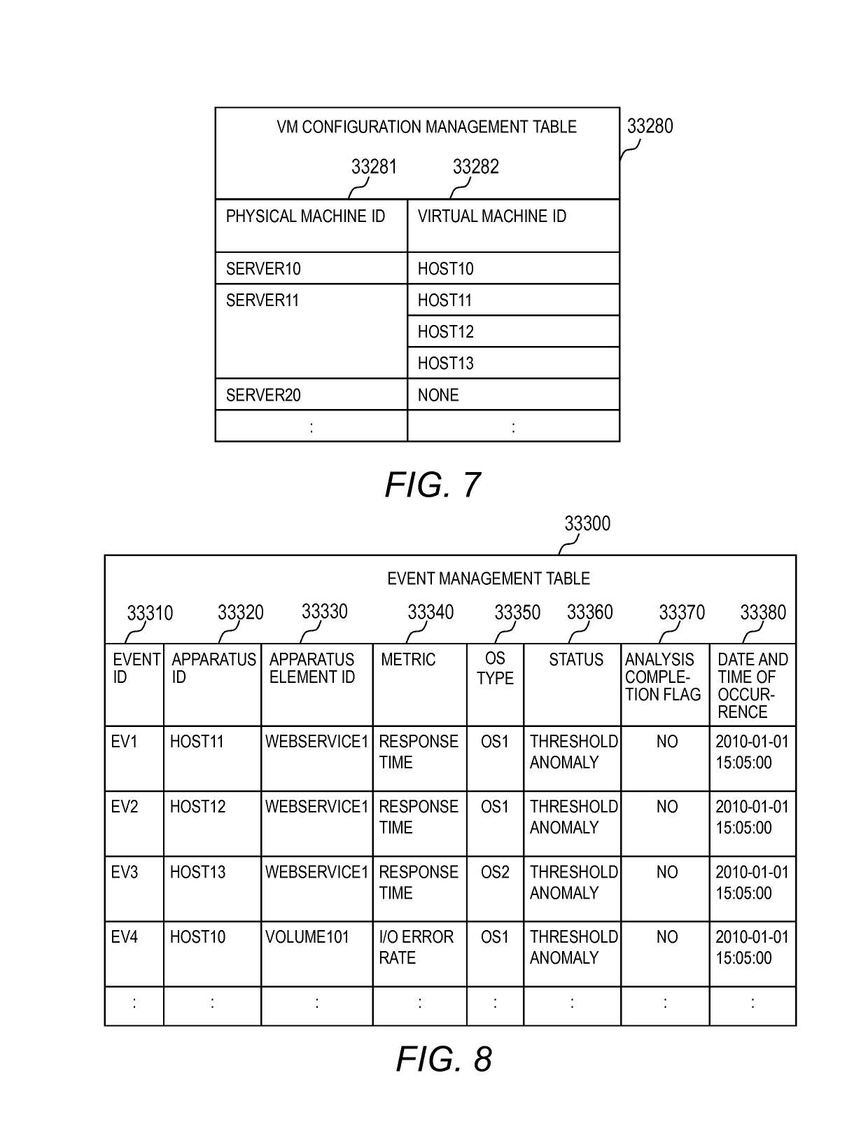

FIG. 7 illustrates a configuration example of the VM configuration management table 33280 held in the management server computer 30000.

The VM configuration management table 33280 manages configuration information on VMs or hosts, and includes a plurality of items.

Each field 33281 stores the ID of a physical machine or a host computer running a virtual machine (VM). Each field 33282 stores the ID of a virtual machine running on the physical machine.

For example, the first row (first entry) in FIG. 7 indicates that, on a host computer identified by a physical machine ID of SERVER10, a virtual machine identified by an ID of HOST10 is running.

### <Configuration of Event Management Table>

FIG. 8 illustrates a configuration example of the event management table 33300 held in the management server computer 30000. The event management table 33300 manages events that occurred and is referred to in later-described failure cause analysis and plan expansion/plan execution effect analysis as necessary.

The event management table 33300 includes a plurality of items. Each field 33310 stores the ID of an event. Each field 33320 stores the ID of an apparatus in which the event such as a threshold anomaly in the acquired performance data occurred. Each field 33330 stores the ID of an element of the apparatus where the event occurred.

Each field 33340 registers the name of a metric on which the threshold anomaly was detected. Each field 33350 stores the type of the OS in the apparatus where the threshold anomaly was detected. Each field 33360 indicates a status of the element in the apparatus when the event occurred. Each field 33370 indicates whether the event has been analyzed by the later-described failure cause analysis program 1140. Each field 33380 stores a date and time the event occurred.

For example, the first row (first entry) in FIG. 8 indicates that the management server computer 30000 detected a threshold anomaly on the response time in the apparatus element WEBSERVICE1 running on the virtual machine HOST11 and the event ID of the event is EV1.

### <Configuration of Analysis Rule>

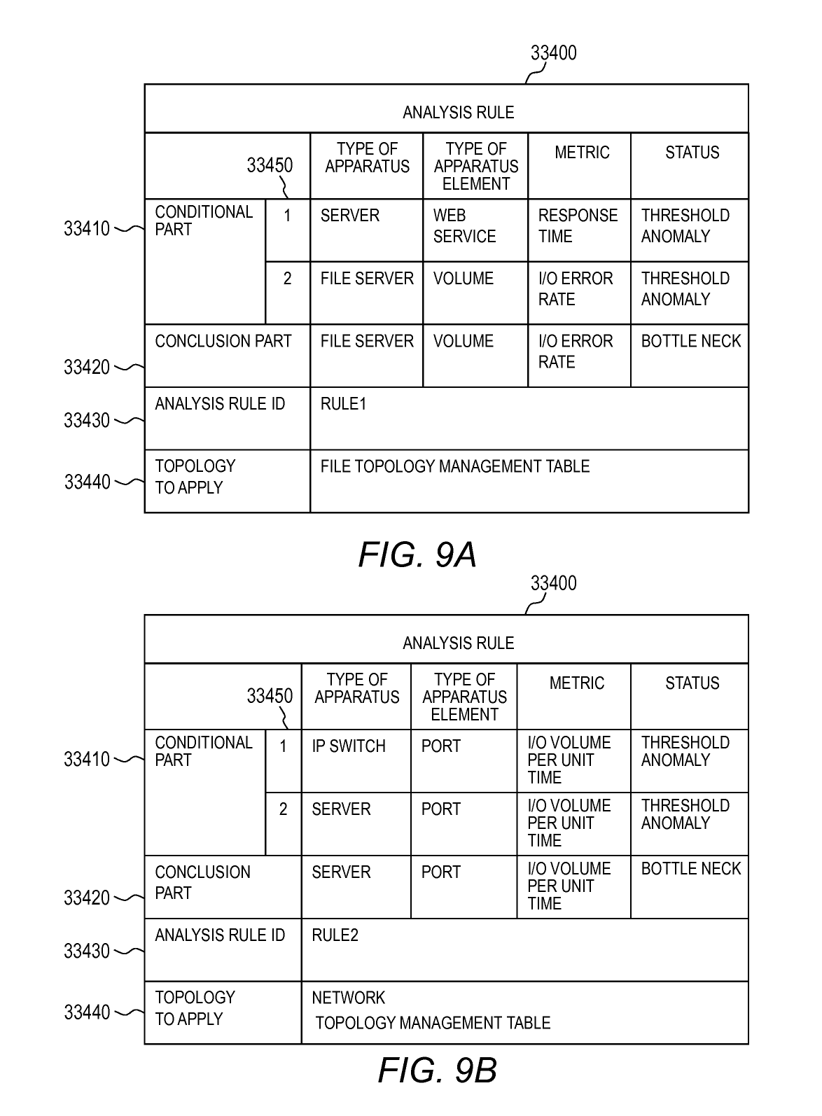

FIGS. 9A and 9B each illustrate a configuration example of an analysis rule in the analysis rule repository 33400 held in the management server computer 30000. The analysis rule indicates a relation between a combination of one or more conditional events that could occur in the apparatuses of the components of the computer system and a conclusion event that should be the failure cause of the combination of the conditional events. Analysis rules are generic rules for causal analysis and the events are defined with the types of system components.

In general, an event propagation model for identifying a cause in failure analysis specifies a combination of events that are expected to occur as a result of some failure and the cause thereof in the “IF-THEN” format. It should be noted that the analysis rules are not limited to those shown in FIGS. 9A and 9B; more rules may be provided.

An analysis rule includes a plurality of items. A field 33430 stores the ID of the analysis rule. A field 33410 stores observed events corresponding to the IF (conditional) part of the analysis rule specified in the “IF-THEN” format. A field 33420 stores a causal event corresponding to the THEN (conclusion) part of the analysis rule specified in the “IF-THEN” format. A field 33440 indicates a topology to acquire in applying the analysis rule to the real system.

The field 33410 includes event IDs 33450 of the events listed in the conditional parts. If an event in the conditional part field 33410 is detected, the event in the conclusion part 33420 is the cause of the failure. If the status of the conclusion part field 33420 changes to be normal, the problems in the conditional part field 33410 are solved. In each of the examples of FIGS. 9A and 9B, the conditional part field 33410 includes two events; however, there is no limit for the number of events.

The conditional part field 33410 may include only the events that occur primarily from the causal event in the conclusion part field 33420 or events that occur secondarily or as results of the secondary events. The event in the conclusion part field 33420 indicates a root cause of the events in the conditional part field 33410. The conditional part field 33410 consists of the root cause event in the conclusion part field 33420 and derivative events thereof.

If the conditional part field 33410 includes an N-th order derivative event, the direct causal event of the N-th order derivative event is an (N−1)-th order derivative event and the event in the conclusion part field 33420 is a root cause event common to all the derivative events.

Taking an example of the analysis rule identified by an ID of RULE1 in FIG. 9A, if a threshold anomaly in the response time of the web service running on a server (derivative event) and a threshold anomaly in the I/O error rate of the volume in the file server (causal event) are detected as observed events, the analysis rule RULE1 concludes that the threshold anomaly in the I/O error rate of the volume in the file server is the cause. The events to be observed may be defined so that a status on some metric is normal. FIG. 9A further designates the topology defined by the file topology management table 33200 as the topology to apply.

### <Configuration of Analysis Result Management Table>

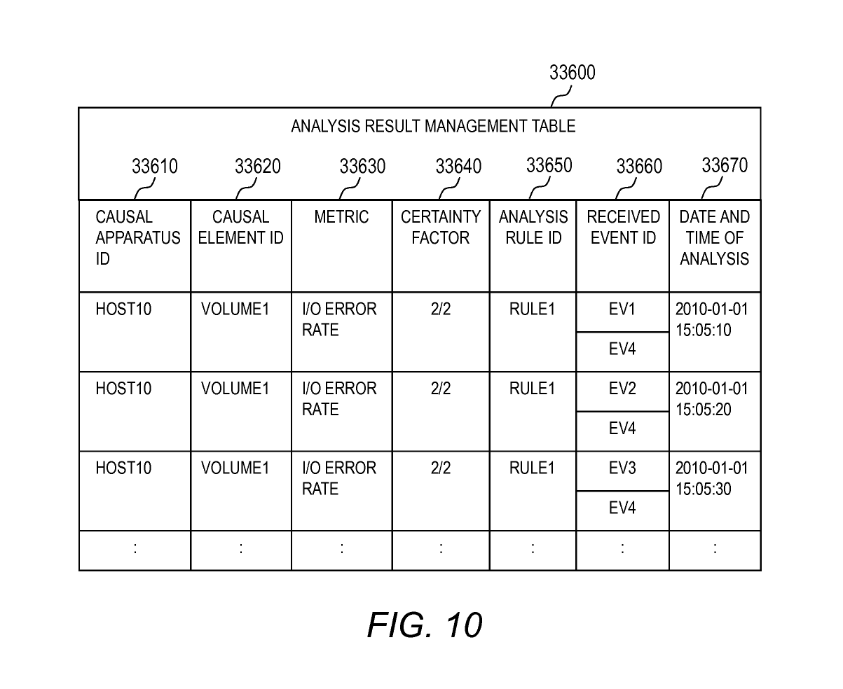

FIG. 10 illustrates a configuration example of the analysis result management table 33600 held in the management server computer 30000. The analysis result management table 33600 stores results of later-described failure cause analysis and includes a plurality of items.

Each field 33610 stores the ID of an apparatus in which an event occurred that has determined to be the failure cause in failure cause analysis. Each field 33620 stores the ID of an element in the apparatus where the event occurred. Each field 33630 stores the name of a metric on which a threshold anomaly was detected.

Each field 33640 stores a rate of occurrence of the events listed in the conditional part 33410 in an analysis rule. Each field 33650 stores the ID of an analysis rule that is the ground of the determination that the event is the failure cause. Each field 33660 stores the ID of an event which was actually received out of the events listed in the conditional part 33410 of the analysis rule. Each field 33670 stores the date and time when failure analysis was started in response to occurrence of an event.

For example, the first row (first entry) in FIG. 10 indicates that the management server computer 30000 has determined that the failure cause is the threshold anomaly in the I/O error rate of the volume identified by VOLUME1 in the virtual machine HOST10 based on the analysis rule RULE1. Furthermore, as the ground of the determination, it indicates that the management server computer 30000 received the events identified by the event IDs EV1 and EV4; in other words, the rate of occurrence of the conditional events is 2/2.

### <Configuration of Generic Plan>

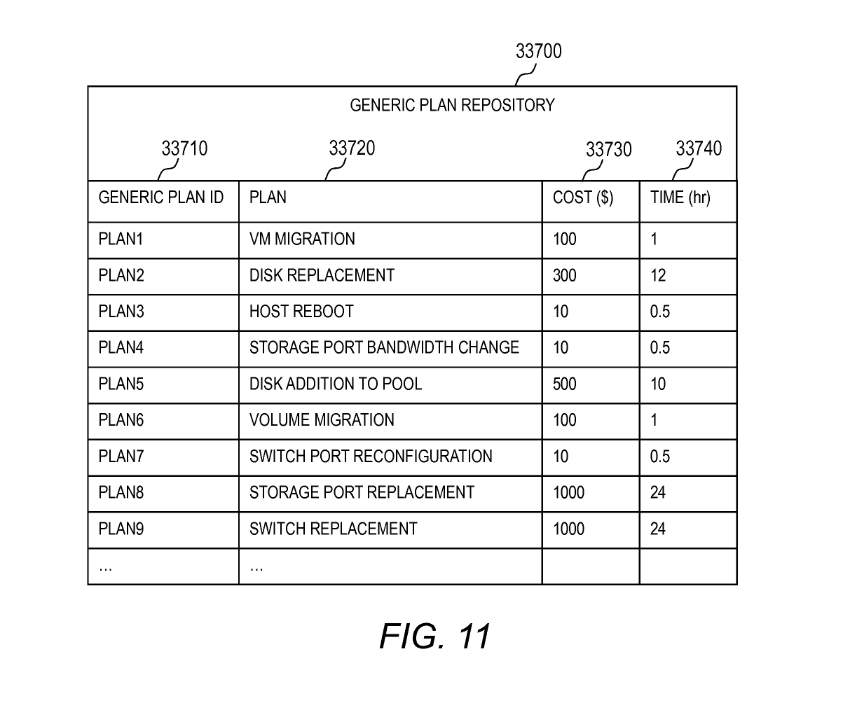

FIG. 11 illustrates a configuration example of the generic plan repository 33700 held in the management server computer 30000. The generic plan repository 33700 provides a list of functions executable in the computer system.

In the generic plan repository 33700, each field 33710 stores a generic plan ID. Each field 33720 stores information on a function executable in the computer system. Examples of the plans include rebooting a host, reconfiguration of a switch, volume migration in the storage, and VM migration. The plans are not limited to those listed in FIG. 11. Each field 33730 indicates the cost required for the generic plan and each field 33740 indicates the time required for the generic plan.

### <Configuration of Expanded Plan>

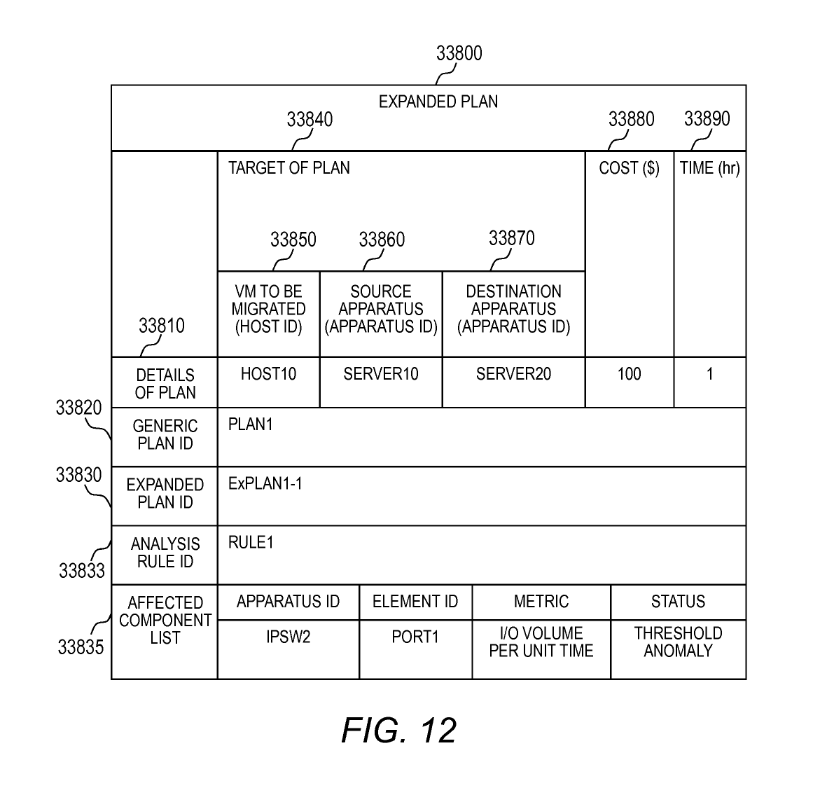

FIG. 12 illustrates an example of an expanded plan stored in the expanded plan repository 33800 held in the management server computer 30000. An expanded plan is information obtained by translating a generic plan into a format depending on the real configuration of the computer system and defines a plan using the identifiers of components.

The expanded plan shown in FIG. 12 is created by the plan creation program 1160. Specifically, the plan creation program 1160 applies information in the entries of the file topology management table 33200, the network topology management table 33250, the VM configuration management table 33280, and the apparatus performance management table 33100 to each entry of the generic plan repository 33700 shown in FIG. 11.

An expanded plan includes a details-of-plan field 33810, a generic plan ID field 33820, an expanded plan ID field 33830, an analysis rule ID field 33833, and an affected component list field 33835. Furthermore, the expanded plan includes a target-of-plan field 33840, a cost field 33880, and a time field 33890.

The details-of-plan field 33810 stores information on the specific processing of the expanded plan and the state after execution thereof on a plan-by-plan basis. The generic plan ID field 33820 stores the ID of the generic plan on which the expanded plan is based.

The expanded plan ID field 33830 stores the ID of the expanded plan. The analysis rule ID field 33833 stores the ID of an analysis rule to provide information for identifying the failure cause to apply the expanded plan. The affected component list field 33835 indicates other components (components) affected by execution of this plan and the kinds of the effects.

The target-of-plan field 33840 indicates the apparatus for which the plan is to be executed (field 33850), configuration information before execution of the plan (field 33860), and configuration information after execution of the plan (field 33870).

The cost field 33880 and the time field 33890 specify the workload to execute the plan. It should be noted that the cost field 33880 and the time field 33890 may store any values representing workload as far as they are measures for evaluating the plan; they may indicate the effects how much improvement can be attained by executing the plan.

FIG. 12 illustrates an example based on the generic plan PLAN1 (VM migration plan) in the generic plan repository 33700 in FIG. 11 and the analysis rule RULE1. As shown in FIG. 12, the expanded plan of PLAN1 includes a VM to be migrated (field 33850), a source apparatus (field 33860), a destination apparatus (field 33870), a cost required for the migration (field 33880), and a time required for the migration (field 33890).

In the case where the expanded plan includes a value representing workload and a value representing improvement caused by executing the plan, any method of calculating those values may be employed. For simplicity, this example is assumed to have predefined those values in relation to the plans in FIG. 11 in some way.

This disclosure specifically describes only the example of the expanded plan of PLAN1 (VM migration plan), but expanded plans of the other generic plans held in the generic plan repository 33700 shown in FIG. 11 can be created likewise.

### <Configuration of Rule-and-Plan Association Management Table>

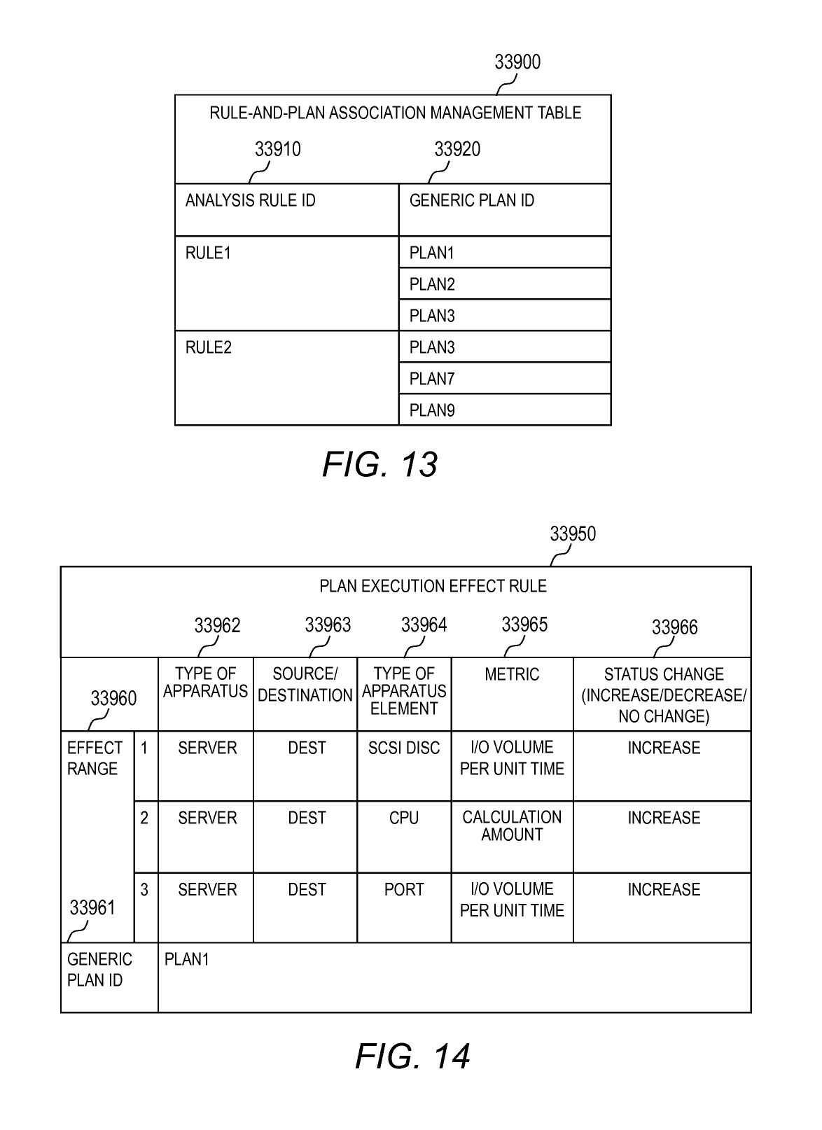

FIG. 13 illustrates an example of the rule-and-plan association management table 33900 held in the management server computer 30000. The rule-and-plan association management table 33900 provides analysis rules identified by the analysis rule IDs and lists of plans executable when a failure cause has been identified by applying each analysis rule.

The rule-and-plan association management table 33900 includes a plurality of items. Each analysis rule ID field 33910 stores the ID of an analysis rule. The values of the analysis rule IDs are common to those of the analysis rule ID fields 33430 in the analysis rule repository. Each generic plan ID field 33920 stores the ID of a generic plan. Generic plan IDs are common to the values in the generic plan ID fields 33710 in the generic plan repository 33700.

### <Configuration of Plan Execution Effect Rule>

FIG. 14 illustrates an example of a plan execution effect rule provided by the plan execution effect rule repository 33950 held in the management server computer 30000. The plan execution effect rule is a generic rule indicating effects of execution of a generic plan.

The generic plan execution effect rule provides a list of components which are affected by execution of a generic plan identified by the generic plan ID field 33961 in an effect range field 33960. This example indicates the components primarily affected by execution of a plan, in other words, the components directly affected by execution of the plan.

The generic plan ID 33961 is common to the values of the generic plan ID fields 33710 in the generic plan repository 33700. Each entry of the effect range field 33960 includes a plurality of fields. A type-of-apparatus field 33962 indicates the apparatus type of the affected apparatus. A source/destination field 33963 indicates whether the apparatus is affected if the apparatus is a source apparatus in the expanded plan or if the apparatus is a destination apparatus.

A type-of-apparatus-element field 33964 specifies the type of an affected apparatus element. A metric field 33965 indicates an affected metric. A status field 33966 indicates the manner of change. The effect range field 33960 may include any field depending on the associated generic plan.

FIG. 14 illustrates an example associated with PLAN1 (VM migration plan) in the generic plan repository 33700 in FIG. 11. The first entry indicates that, if an apparatus of the apparatus type SERVER is a destination apparatus, the metric of the I/O volume per unit time in the SCSI disc might increase.

### <Acquiring Configuration Management Information and Updating Topology Management Table>

A program control program in the management server computer 30000 instructs the configuration management information acquisition program 1120 to periodically acquire, for example by polling, configuration management information from the storage apparatuses, host computers, and IP switches in the computer system.

The configuration management information acquisition program 1120 acquires configuration management information from the storage apparatuses, host computers, and IP switches. The configuration management information acquisition program 1120 updates the file topology management table 33200, the network topology management table 33250, the VM configuration management table 33280, and the apparatus performance management table 33100 with the acquired information.

### <Overall Processing Flow>

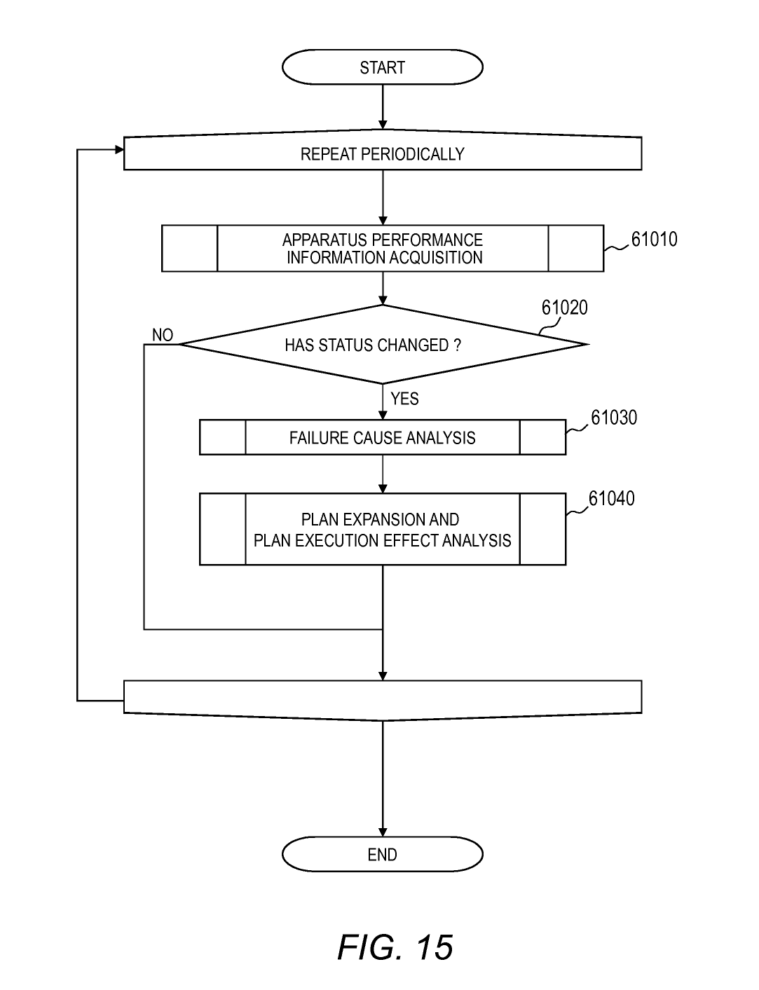

FIG. 15 is a chart illustrating an overall flow of the processing in this embodiment. First, the program control program in the management server computer 30000 executes apparatus performance information acquisition (Step 61010).

The program control program instructs the apparatus performance information acquisition program 1110 to perform apparatus performance information acquisition at the start of the program or every time a predetermined time has passed since the previous apparatus performance information acquisition. In the case of repeating this instruction, the cycle does not need to be constant.

At Step 61010, the apparatus performance information acquisition program 1110 instructs each apparatus being monitored to send performance information. The program 1110 stores returned information in the apparatus performance management table 33100 and determines the status with respect to the threshold.

In the case where the previous performance data has been acquired and the current status with respect to the threshold is different from the previous one (Step 61020: YES), the apparatus performance information acquisition program 1110 registers the event in the event management table 33300. The failure cause analysis program 1140 that has received an instruction from the apparatus performance information acquisition program 1110 executes failure cause analysis (Step 61030).

After execution of the failure cause analysis, the plan creation program 1160 and the plan execution effect analysis program 1180 execute plan expansion and plan execution effect analysis (Step 61040).

The following description describes Step 61030 and the subsequent steps following this flow. It should be noted that the application of this invention is not limited to the analysis of effects of plan execution in planning a solution at occurrence of a failure; when a plan accompanied by a configuration change in a computer system is created with some intention of the administrator, only later-described Step 63050 may be executed to evaluate the effects of execution of the plan.

Step 61030 and the subsequent steps are outlined. The management server computer 30000 selects an analysis rule applicable to an event selected from the event management table 33300 from the analysis rule repository 33400.

The management server computer 30000 selects a generic plan associated with the selected analysis rule with reference to the rule-and-plan association management table 33900. The management server computer 30000 creates an expanded plan, which is a specific solution plan to be executed by the computer system, from the selected generic plan and the configuration information (tables 33200, 33250, and 33280).

The management server computer 30000 identifies the events that could occur as the effects of execution of the expanded plan from plan execution effect rules (plan execution effect rule repository 33950) and the configuration information (tables 33200, 33250, and 33280). Each plan execution effect rule defines the types of the components primarily affected by execution of a plan and specifics of the effects.

The management server computer 30000 selects analysis rules including the events as a causal event (conclusion event) and identifies derivative events of these events. The management server computer 30000 stores information on the derivative events in the affected component list 33835 in the expanded plan.

### <Processing Flow of Failure Cause Analysis (Step 61030)>

The apparatus performance information acquisition program 1110 instructs the failure cause analysis program 1140 to execute failure cause analysis (Step 61030) if a newly added event exists. The failure cause analysis (Step 61030) is performed through matching the event with each analysis rule stored in the analysis rule repository 33400. The analysis result defines the event with the identifiers of components.

In the matching, the failure cause analysis program 1140 performs matching of failure events in the event management table 33300 that have been registered in a predetermined period with each analysis rule. If some event occurs in any type of component included the conditional part of an analysis rule, the failure cause analysis program 1140 calculates a certainty factor and writes it to the analysis result management table 33600.

For example, the analysis rule RULE1 shown in FIG. 9A defines “a threshold anomaly in response time of the web service on a server” and “a threshold anomaly in I/O error rate in a volume in a file server” in the conditional part 33410.

When the event EV1 (the date and time of occurrence: 2010-01-01 15:05:00) is registered in the event management table 33300 shown in FIG. 8, the failure cause analysis program 1140 stands by for a predetermined time and then acquires events that occurred during a predetermined period in the past with reference to the event management table 33300. The event EV1 represents “a threshold anomaly in response time of WEBSERVICE1 on HOST11”.

Next, the failure cause analysis program 1140 calculates the number of events that occurred in the predetermined period in the past and correspond to the conditional part specified in RULE1. In the example of FIG. 8, the event EV4 “a threshold anomaly in I/O error rate in VOLUME101 in HOST10 (file server)” also occurred during a predetermined period in the past. This is the second event in the conditional part field 33410 in RULE1 and is a causal event (the conclusion part field 33420).

Accordingly, the ratio of the number of events that occurred (the causal event and a derivative event) and correspond to the conditional part 33410 specified in RULE1 to the number of all events specified in the conditional part 33410 is 2/2. The failure cause analysis program 1140 writes this result to the analysis result management table 33600.

The failure cause analysis program 1140 executes the foregoing processing on all the analysis rules defined in the analysis rule repository 33500.

Described above is the explanation of the failure cause analysis executed by the failure cause analysis program 1140. The above-described example uses the analysis rule shown in FIG. 9A and the events registered in the event management table 33300 shown in FIG. 8, but the method of the failure cause analysis is not limited to this.

If the ratio calculated as described above is higher than a predetermined value, the failure cause analysis program 1140 instructs the plan creation program 1160 to create a plan for failure recovery. For example, the predetermined value is assumed to be 30%. In this specific example, the analysis result written to the first entry in the analysis result management table 33600 shows the rate of occurrence of the events in the predetermined period in the past is 2/2, which is 100%. Accordingly, the plan creation program 1160 is instructed to create a plan for failure recovery.

### <Processing Flow of Obtaining Solution Plans (Step 61040)>

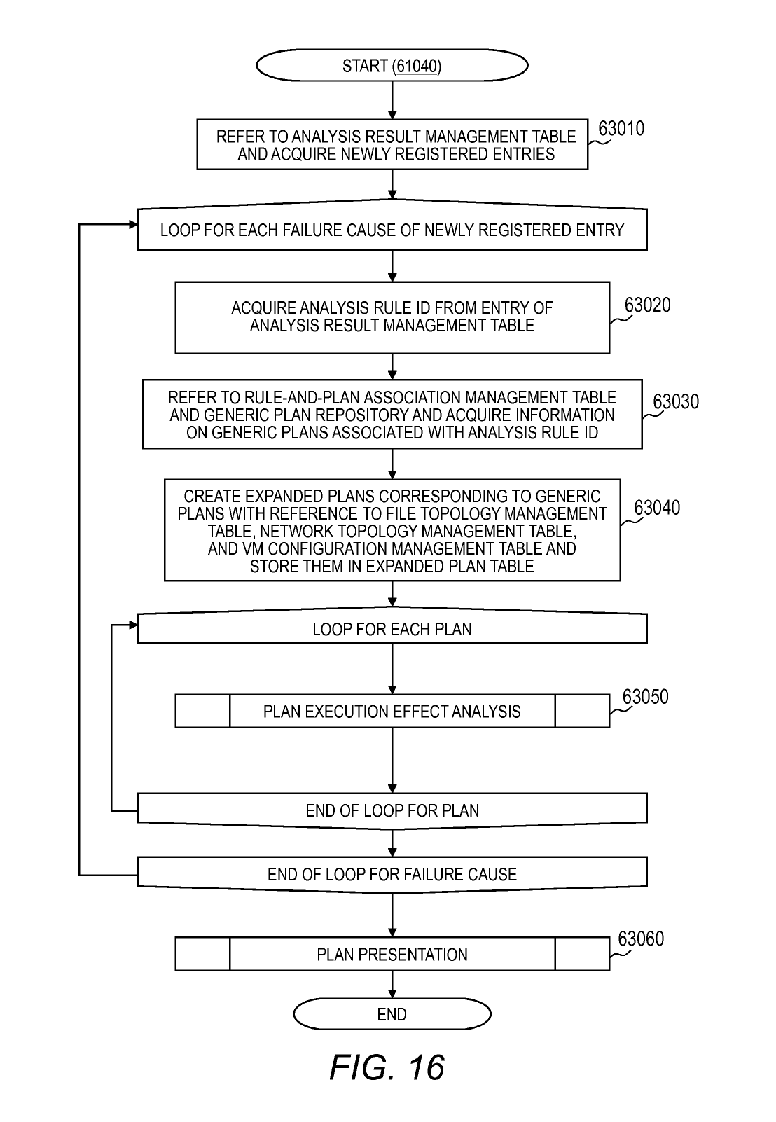

FIG. 16 is a flowchart illustrating the processing of plan expansion (Step 61040) performed by the plan creation program 1160 in the management server computer 30000 in this embodiment.

The plan creation program 1160 refers to the analysis result management table 33600 and acquires newly registered entries (Step 63010). The plan creation program 1160 performs the following steps 63020 to 63050 on each newly registered entry, or each failure cause.

The plan creation program 1160 first acquires the analysis rule ID from the field 33650 of the entry in the analysis result management table 33600 (Step 63020). Next, the plan creation program 1160 refers to the rule-and-plan association management table 33900 and the generic plan repository 33700 and acquires generic plans associated with the acquired analysis rule ID (Step 63030).

Next, the plan creation program 1160 creates expanded plans corresponding to each of the acquired generic plans with reference to the file topology management table 33200, the network topology management table 33250, and the VM configuration management table 33280 and stores them in an expanded plan table in the expanded plan repository 33800 (Step 63040).

By way of example, a method of creating the expanded plan shown in FIG. 12 is described. The plan creation program 1160 creates a table of expanded plans associated with PLAN 1. The plan creation program 1160 stores HOST10 in the field 33850 for the VM to be migrated. The plan creation program 1160 acquires the physical machine ID SERVER 10 of HOST10 from the VM configuration management table 33280 and stores it in the field 33860 for the source apparatus.

The plan creation program 1160 acquires the IDs of the physical machines connected with SERVER10 from the network topology management table 33250. The plan creation program 1160 refers to the VM configuration management table 33280 and selects the IDs of the physical machines which can run a VM from the acquired physical machine IDs. The plan creation program 1160 creates expanded plans for a part or all of the selected physical machine IDs. FIG. 12 shows an expanded plan for one selected physical machine. In this example, the physical machine ID SERVER20 is selected and stored in the field 33870 for the destination apparatus.

The plan creation program 1160 acquires information on cost and information on time from the generic plan repository and stores them to the cost field 33880 and the time field 33890, respectively. Furthermore, it stores the selected generic plan ID and analysis rule ID in the generic plan ID field 33820 and the analysis rule ID field 33833, respectively. The plan creation program 1160 stores the ID for the created expanded plan in the expanded plan ID field 33830.

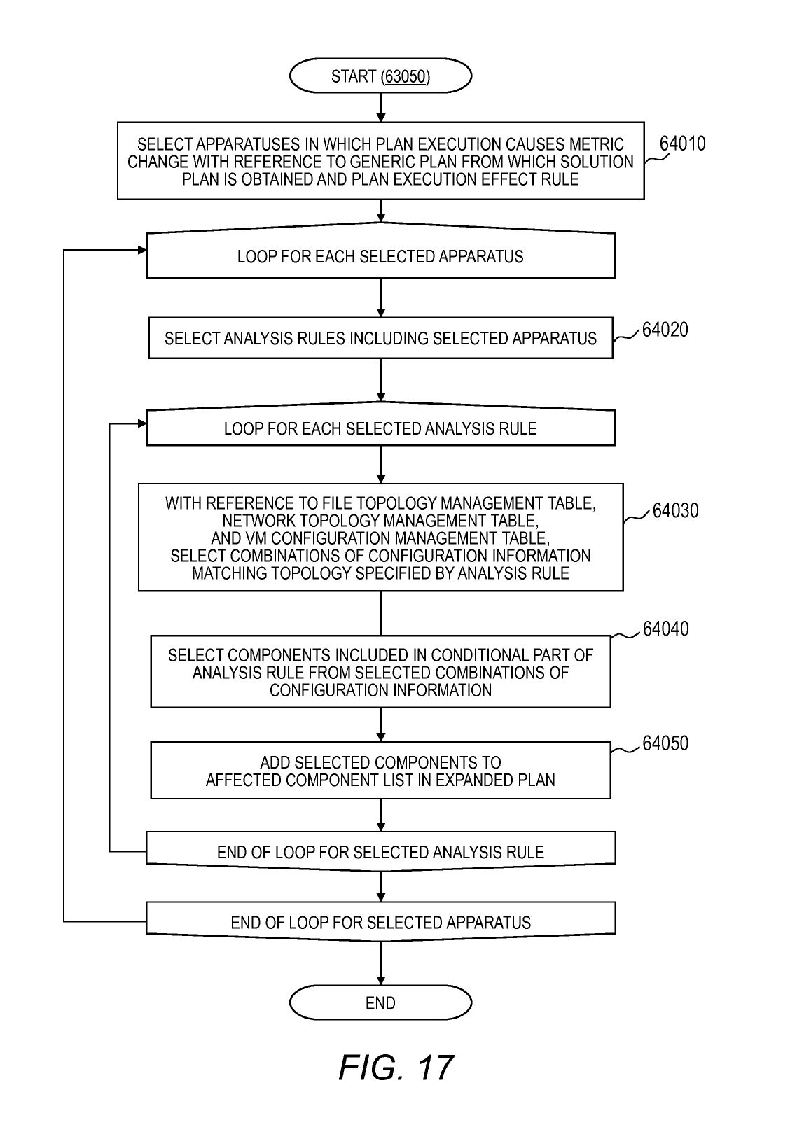

The plan creation program 1160 stores information on the affected range identified by later-described plan execution effect analysis (Step 61040 in FIG. 15 and FIG. 17) to the affected component list 33835.

Subsequently, the plan creation program 1160 instructs the plan execution effect analysis program 1180 to perform plan execution effect analysis (Step 63050). Although no reference is provided here, effects of each expanded plan indicating how much improvement can be attained by executing the expanded plan may be calculated through a simulation after execution of the expanded plan.

After completion of processing on all the failure causes, the plan creation program 1160 requests the image display program 1190 to present the plans (Step 63060) and terminates the processing.

### <Details of Plan Execution Effect Analysis (Step 63050)>

FIG. 17 is a flowchart illustrating the plan execution effect analysis (Step 63050) performed by the plan execution effect analysis program 1180.

First, the plan execution effect analysis program 1180 acquires, from the plan execution effect analysis rule repository 33950, a plan execution effect rule associated with the generic plan from which the expanded plan is obtained. The plan execution effect analysis program 1180 identifies the types of the components in which the metric changes by executing the plan with reference to the acquired plan execution effect analysis rule (Step 64010). The type of each component is represented by a type of apparatus and a type of apparatus element.

The plan execution effect analysis program 1180 performs the following Steps 64020 to 64050 on each of the selected types of component. In the Steps 64020 to 64050, the plan execution effect analysis program 1180 selects, from the analysis rule repository 33400, analysis rules including the type of apparatus and type of apparatus element matching the selected type of component in the conclusion part field 33420 (Step 64020). That is to say, the plan execution effect analysis program 1180 selects analysis rules in which the type of apparatus and the type of apparatus element in the causal event match the type of apparatus and the type of apparatus element in the selected type of component.

It should be noted that, if the conditional part field 33410 of an analysis rule includes an event to be the causal event of a different event, the plan execution effect analysis program 1180 may select an analysis rule including the type of apparatus and type of apparatus element matching the selected type of component in the conditional part field 33410.

The plan execution effect analysis program 1180 performs Steps 64030 to 64050 on each of the selected analysis rules. First, the plan execution effect analysis program 1180 refers to the file topology management table 33200, the network topology management table 33250, and the VM configuration management table 33280 to select combinations of configuration information matching the topologies specified by the analysis rule (Step 64030).

The plan execution effect analysis program 1180 performs Steps 64040 and 64050 on the components that are included in the selected combinations of configuration information but have not been selected at Step 64010 from the components included in the conditional part of the analysis rule. The components that have not been selected at Step 64010 from the components included in the conditional part of the analysis rule are the components that are secondarily affected by the effects on the components listed in the plan execution effect rule. In other words, the effects of execution of the plan propagate to other components via the apparatus elements listed in the plan execution effect rule.

At Step 64040, the plan execution effect analysis program 1180 selects the apparatus IDs, the apparatus element IDs, and the metrics and statuses specified by the conditional part 33410 of the analysis rule. At Step 64050, the plan execution effect analysis program 1180 adds them to the affected component list 33835 in the corresponding expended plan.

Taking an example of FIG. 12 for migration of HOST10 of a VM from SERVER10 to SERVER 10 in accordance with PLAN1, the plan execution effect analysis program 1180 first recognizes, from the generic plan PLAN1 and the plan execution effect rule (FIG. 14), that I/O volume per unit time of the SCSI DISC, the calculation amount of the CPU, and the I/O volume per unit time of the port in the host computer SERVER20 at the destination will change in executing this plan (Step 64010).

As shown in FIG. 14, the changes in values in this example are increase. Further, the plan execution effect analysis program 1180 selects analysis rules including the corresponding event as a causal event in the conclusion part field 33420 for each of the SCSI DISC, CPU, and port of the selected SERVER20 (Step 64020). In this example, the event of a change in I/O volume per unit at the port of the server is included in the conclusion part field 33420 in the analysis rule of FIG. 9B. Accordingly, this analysis rule is selected.

Next, the plan execution effect analysis program 1180 selects a combination of components matching the topology specified by the selected analysis rule from the network topology management table 33250. The conditional part field 33410 lists the types of the connected components. In this example, the plan execution effect analysis program 1180 selects the combination of PORT201 of SERVER20 and PORT1 of IPSW2 (Step 64030).

For PORT1 of IPSW2 that is not selected at Step 64010 among the components included in the selected combinations, the plan execution effect analysis program 1180 adds the metric (I/O volume per unit time) and the status (threshold anomaly) specified in the conditional field 33410 of the analysis rule to the affected component list 33835 (Step 64050). The affected component list 33835 indicates events that could occur because of the side-effects of the execution of the plan.

### <Details of Plan Presentation (Step 63060)>

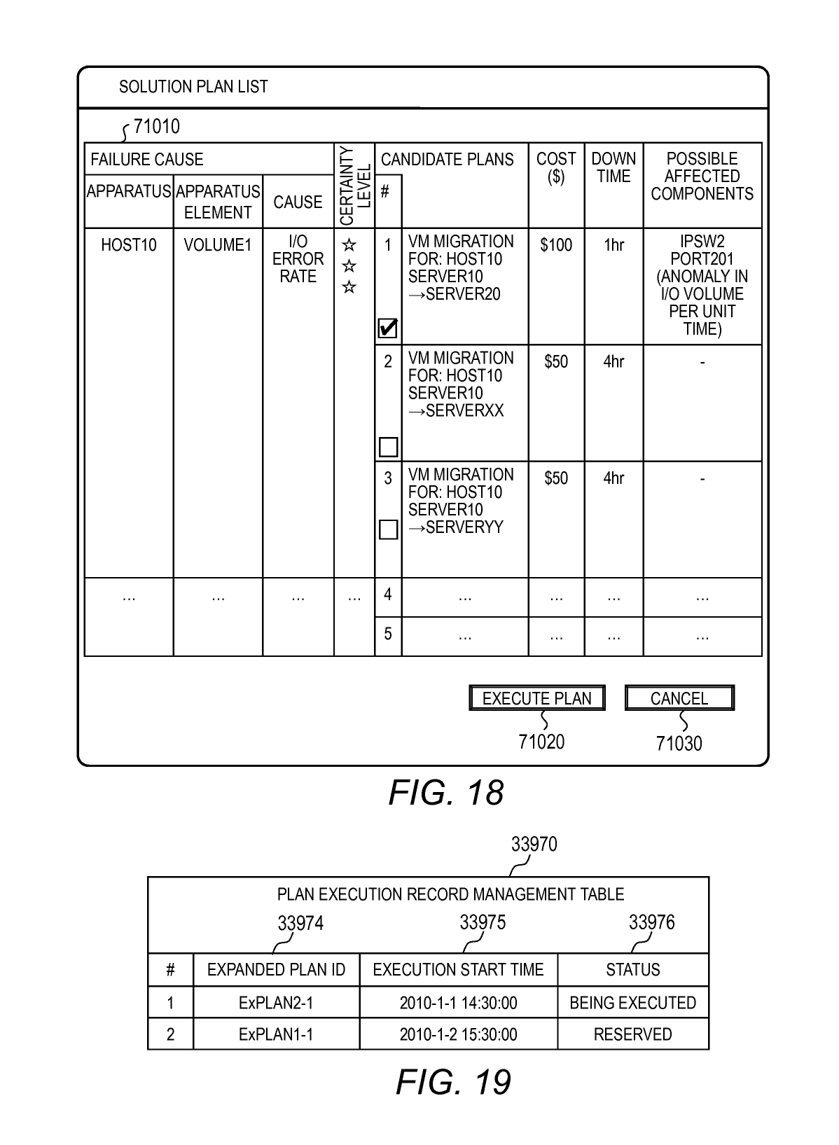

FIG. 18 illustrates an example of a solution plan list image output to the output device 31200 at Step 63060. In the example of FIG. 18, when the administrator of a computer system investigates the cause of a failure occurring in the system to cope with the failure, the indication area 71010 shows association relations between components of possible failure causes and lists of solution plans selectable to cope with the failure. The EXECUTE PLAN button 71020 is a selection button to execute a solution plan. The button 71030 is a button to cancel the image display.

The indication area 71010 for showing the association relations between the failure cause and solution plans for a failure includes the ID of an apparatus of the failure cause, the ID of an apparatus element of the failure cause, the type of a metric determined to be failed, and a certainty level for information on the failure cause. The certainty level is represented by the ratio of the number of events that have actually occurred to the number of events that should occur according to an analysis rule.

The image display program 1190 acquires the failure cause (the causal apparatus ID field 33610, the causal element ID field 33620, and the metric field 33630) and the certainty level (the certainty factor field 33640), from the analysis result management table 33600, creates display image data, and displays an image.

The information on failure solution plans includes candidate plans, costs required to execute the plans, and the times required to execute the plans. Furthermore, it includes the time length for which the failure will remain and the components which might be affected derivatively.

In order to display the information on failure solution plans, the image display program 1190 acquires information from the acquired target-of-plan fields 33840, cost fields 33880, time fields 33890, affected component list fields 33835 in the expanded plan repository 33800. The indication area for each candidate plan includes a checkbox so that the user can select a plan to execute when pressing the later-described EXECUTE PLAN button 71020.

The EXECUTE PLAN button 71020 is an icon for requesting to execute a selected plan. The administrator presses the EXECUTE PLAN button 71020 with the input device 31300 to execute one plan for which the checkbox has been selected. This execution of a plan is performed by executing a series of specific commands associated with the plan.

FIG. 18 is an example of the display image and the indication area 71010 may display information representing characteristics of each plan other than the cost and time required to execute the plan; alternatively, it may adopt a different manner of indication. The management server computer 30000 may execute an automatically selected plan without receiving input from the administrator or have no function to execute plans.

The foregoing first embodiment can inform the user of the existence of effects of a solution plan before executing the solution plan, if a possibility that the plan might affect other components has been found in creating the plan. In this way, the system administrator preparing a failure solution plan can decide whether to execute the failure solution plan in consideration of the existence of the affected apparatuses, achieving reduction in the operation management cost to analyze the effects of some change in a computer system.

The foregoing example presents components to be affected by execution of a plan, but this is not requisite. For example, the management server computer 30000 may schedule and execute a plan in accordance with the analysis result of the plan execution effect without displaying the result.

Analyzing the effects of execution of a plan requiring a configuration change in the computer system with analysis rules for failure cause analysis achieves proper and efficient plan execution effect analysis. The management server computer 30000 may hold analysis rules for plan execution effect analysis separate from analysis rules for failure cause analysis.

### Second Embodiment

The second embodiment is described. In the following, differences from the first embodiment are mainly described; descriptions about like elements, programs having like functions, and tables including like items are omitted.

This embodiment determines whether a plan including configuration change affects a different plan being executed or scheduled to be executed, if any, schedules the plan based on the determination result, and presents information of the schedule to the system administrator. Furthermore, this embodiment estimates the progress of plan execution and presents when the system will recover by the plan execution.

The first embodiment presents the existence of other components that might be affected by execution of a solution plan, when creating the plan. The solution plan is executed in response to a press of the EXECUTE PLAN button 71020 after created.

The first embodiment does not consider that time is required to execute of a plan. In other words, when creating a plan by plan expansion, a plan executed previously may be still being executed so that the plan being created might affect the execution of the plan.

Since the first embodiment does not consider such a possibility, a selected plan is immediately executed when the EXECUTE PLAN button 71020 is pressed; as a result, the execution of the selected plan affects the plan being executed.

In the second embodiment, the management server computer 30000 manages execution of plans so as to minimize such effects. The memory 32000 of the management server computer 30000 holds a plan execution program, a plan execution record program, and a plan execution record management table 33970 in addition to the information (including programs, tables, and repositories) in the first embodiment.

In executing a plan upon press of the EXECUTE PLAN button 71020 in the first embodiment, the plan execution program executes the program. The plan execution record program monitors the status of the execution and records it in the plan execution record management table 33970.

FIG. 19 is a configuration example of the plan execution record management table 33970. The plan execution record management table 33970 includes expanded plan ID fields 33974 for expanded plans being executed, execution start time fields 33975, and fields 33976 for the statuses of execution of the plans.

For example, the first row (first entry) in FIG. 19 indicates that an expanded plan “ExPLAN2-1” was started at “2010-1-1 14:30:00” and is currently being executed. The second row (second entry) in FIG. 19 indicates that an expanded plan “ExPLAN1-1” has been reserved so as to be executed at “2010-1-2 15:30:00”.

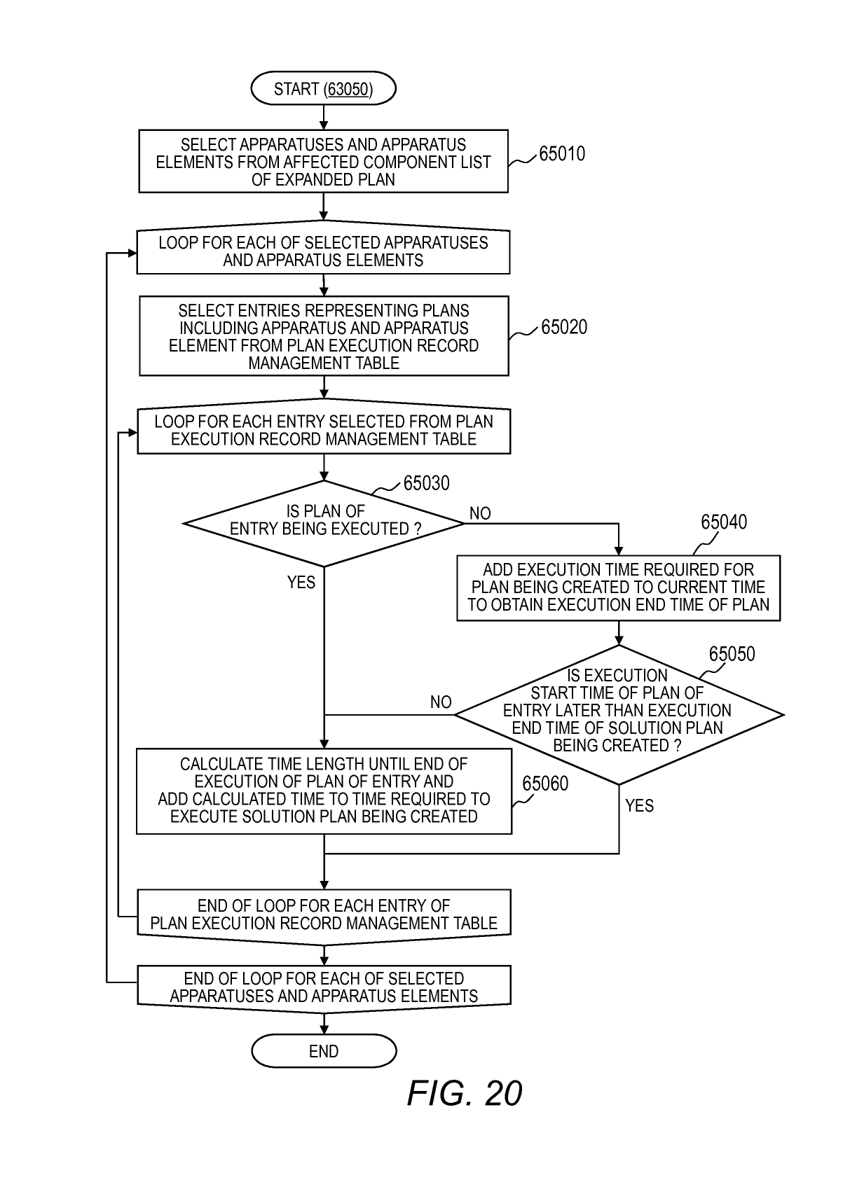

FIG. 20 is a flowchart illustrating determination of plan execution effects on other plans. This processing is performed by the plan execution effect analysis program 1180 in the management server computer 30000 in the second embodiment. From Step 64010 to Step 64050 in the first embodiment, the plan execution effect analysis program 1180 determines whether execution of an expanded plan may affect any component.

In the second embodiment, the plan execution effect analysis program 1180 determines whether execution of an expanded plan affects each plan recorded in the plan execution record management table 33970, immediately after Step 64050.

The plan execution effect analysis program 1180 selects components determined in the first embodiment that the expanded plan may affect from the affected component list 33835 of the expanded plan (Step 65010). The plan execution effect analysis program 1180 performs Steps 65020 to 65060 on each of the selected components. First, with reference to expanded plans in the expanded plan repository 33800 and the plan execution record management table 33970, the plan execution effect analysis program 1180 selects entries of the plan execution record management table 33970 that represent the expanded plans specifying the selected apparatus element of the apparatus (Step 65020).

If such expanded plans are included in the plan execution record management table 33970, the expanded plan being created might affect execution of the expanded plan being executed or reserved to be executed. Accordingly, the plan execution effect analysis program 1180 performs Steps 65030 to 65060 on each of the selected entries.

The plan execution effect analysis program 1180 refers to the entry selected at Step 65020 and determines whether the plan included in the entry is being executed from the status field 33976 of the plan execution record management table 33970 (Step 65030).

If the plan is not being executed (Step 65030: NO), the plan execution effect analysis program 1180 adds the value in the time field 33890 required to execute the plan being created (the expanded plan handled at Step 65010) to the current time to calculate the end time of the execution of the plan (Step 65040).

The plan execution effect analysis program 1180 determines whether the value of the execution start time field 33975 in the selected entry is after the calculated execution end time (Step 65050).

If the value of the execution start time field 33975 in the entry is later than the calculated execution end time (Step 65050: YES), the execution of the plan being created does not affect the execution of the plan in the entry.

However, if the plan in the entry is being executed (Step 65030: YES) or if the value of the execution start time field 33975 in the entry is earlier than the calculated execution end time (Step 65050: NO), the execution of the plan being created affects the execution of the plan in the entry.

In either case, the plan execution effect analysis program 1180 calculates the time until the end of execution of the plan in the entry. This is obtained by calculating a difference between the sum of the value of the execution start time field 33975 of the entry added to the value of the time field 33890 in the expanded plan included in the entry and the current time. If the expanded plan being created is executed by the time obtained from the current time, it affects the execution of the expanded plan included in the entry.

The second embodiment may avoid executing the expanded plan being created during this period, for example. That is to say, the expanded plan being created is scheduled so that the execution period of the expanded plan being created will not overlap with the execution period of the expanded plan being executed or reserved to be executed. If the effect is small, the two periods may overlap.

The plan execution effect analysis program 1180 adds the obtained time to the execution time for the expanded plan being created and updates the value in the time field 33890 of the expanded plan. In updating, it records the time which does not permit execution of the plan in the time field 33890 to be distinguishable (Step 65060).

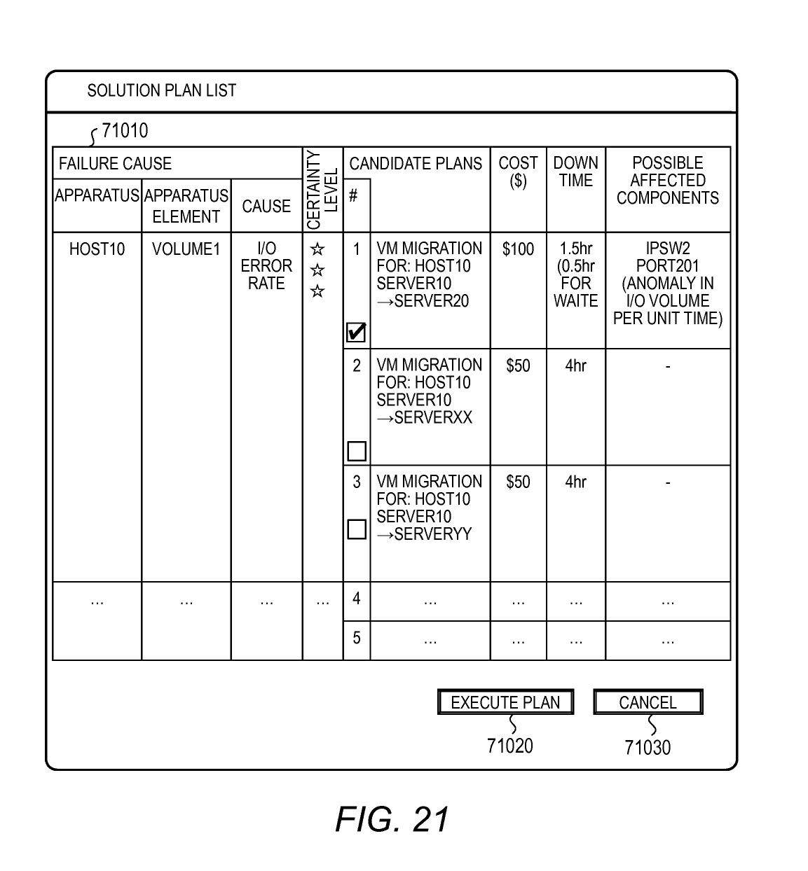

FIG. 21 illustrates an example of a solution plan list output at Step 63060 in the second embodiment. The difference from the image in FIG. 18 is the part related to the time required to execute the plan, which is indicated as information on the solution plan. This part is changed so as to indicate the value obtained by addition at Step 65060 and the time which does not permit execution of the plan.

When the EXECUTE PLAN button 71020 is pressed, the plan execution program executes the plan like in the first embodiment. The plan execution program determines whether any time exists which does not permit execution of the plan from the time field 33890 of the expanded plan.

If such a time does not exist, the plan execution program immediately execute the series of commands associated with the plan and records the start time and the status of being executed in the execution start time field 33975 and the status field 33976 of the corresponding entry in the plan execution record management table 33970. If the time which does not permit execution of the plan exists, the plan execution program records the time obtained by adding the time to the current time and the status of reserved to the execution start time field 33975 and the status field 33976, respectively.

According to the above-described second embodiment, in addition to identification of the components affected by execution of each solution plan in the first embodiment, the existence of a plan being executed or a reserved plan can be considered to create the solution plan. If such a plan exists, the execution start time of the solution plan being created can be controlled.

In this way, in creating a failure solution plan, the system administrator can consider the existence of an apparatus which the plan may affect, and further can appropriately schedule the execution of the plan in consideration of the completion of execution of a different plan that the play may affect. As a result, the system management cost for analyzing the effects and scheduling in changing the computer system can be reduced.

This invention is not limited to the above-described examples but includes various modifications. The above-described examples are explained in details for better understanding of this invention and are not limited to those including all the configurations described above. A part of the configuration of one example may be replaced with that of another example; the configuration of one example may be incorporated to the configuration of another example. A part of the configuration of each example may be added, deleted, or replaced by that of a different configuration.

The above-described configurations, functions, and processing units, for all or a part of them, may be implemented by hardware: for example, by designing an integrated circuit. The above-described configurations and functions may be implemented by software, which means that a processor interprets and executes programs for performing the functions. The information of programs, tables, and files to implement the functions may be stored in a storage device such as a memory, a hard disk drive, or an SSD (Solid State Drive), or a storage medium such as an IC card, or an SD card.

What is claimed is:

1. A management system for managing a computer system including a plurality of apparatuses to be monitored, the management system comprising:
a memory; and
a processor,
the memory holding:
configuration information on the computer system;
analysis rules each associating a causal event that may occur in the computer system with derivative events that may occur by effects of the causal event and defining the causal event and the derivative events with types of components in the computer system; and
plan execution effect rules each indicating types of components that may be affected by a configuration change in the computer system and specifics of the effects,
wherein the processor is configured to:
identify a first event that may occur when a first plan for changing a configuration of the computer system is executed using the plan execution effect rules and the configuration information; and
identify a range where the first event affects using the analysis rules and the configuration information.

2. The management system according to claim 1, further comprising an output device for outputting information on the first plan in association with information on apparatuses included in the range.

3. The management system according to claim 1,
wherein the memory further holds event management information managing events that have occurred in the computer system,
wherein the analysis rules each indicate observed events that may observed in the computer system and a relation between the observed events and the causal event, the observed events including the causal event and the derivative events,
wherein the processor is configured to:
identify a first causal event of a second event that occurs in the computer system using the event management information, the analysis rules, and the configuration information; and
determine the first plan for a solution plan of the first causal event.

4. The management system according to claim 1,
wherein the memory further holds plan execution record management information for recording statuses of execution of plans,
wherein the processor is configured to:
determine, after identifying the affected range, whether the range affects any plan being executed or reserved to be executed included in the plan execution record management information; and
schedule a start time to execute the first plan based on a time required to execute the plan being executed or reserved to be executed in the plan execution record management information.

5. The management system according to claim 4,
wherein the processor is configured to start executing the first plan at the scheduled start time.

6. A method for monitoring and managing a computer system including a plurality of apparatuses to be monitored,
the method performed by a management system including:
configuration information on the computer system;
analysis rules each associating a causal event that may occur in the computer system with derivative events that may occur by effects of the causal event and defining the causal event and the derivative events with types of components in the computer system; and
plan execution effect rules each indicating types of components that may be affected by a configuration change in the computer system and specifics of the effects,
the method comprising:
identifying, by the management system, a first event that may occur when a first plan for changing a configuration of the computer system is executed using the plan execution effect rules and the configuration information; and
identifying, by the management system, a range where the first event affects using the analysis rules and the configuration information.

7. The method according to claim 6, further comprising:
outputting, by the management system, information on the first plan in association with information on apparatuses included in the range.

8. The method according to claim 6,
wherein the management system further includes event management information managing events that have occurred in the computer system,
wherein the analysis rules each indicate observed events that may observed in the computer system and a relation between the observed events and the causal event, the observed events including the causal event and the derivative events,
wherein the method further comprises:
identifying, by the management system, a first causal event of a second event that occurs in the computer system using the event management information, the analysis rules, and the configuration information; and
determining, by the management system, the first plan for a solution plan of the first causal event.

9. The method according to claim 6,
wherein the management system further includes plan execution record management information for recording statuses of execution of plans,
wherein the method further comprises:
determining, by the management system which has identified the affected range, whether the range affects any plan being executed or reserved to be executed included in the plan execution record management information; and
scheduling, by the management system, a start time to execute the first plan based on a time required to execute the plan being executed or reserved to be executed in the plan execution record management information.

10. The method according to claim 9, further comprising:
starting, by the management system, executing the first plan at the scheduled start time.
